(19) United States
(12) Patent Application Publication
(10) Pub. No.: US 2011/0010229 A1
(43) Pub. Date: Jan. 13, 2011

(54) METHOD FOR DIGITAL COUPON DISTRIBUTION AND CLEARING

(76) Inventor: Steven G. Ow, Santa Rosa Valley, CA (US)

Correspondence Address: Cislo & Thomas LLP, 1333 2nd Street, Suite #500, Santa Monica, CA, 90401-4110, US

(21) Appl. No.: 12/778,117

(22) Filed: May 11, 2010

Related U.S. Application Data
(60) Provisional application No. 61/215,892, filed on May 11, 2009.

(51) Int. Cl. G06Q 30/00

(52) U.S. Cl. 705/14.1

(57) ABSTRACT

The present invention is a method of distributing, redeeming, and clearing digital coupons that includes transmitting digital coupon data directly to a wireless user communication device such as a user's cell phone and then detecting directly from the device whether any of the digital coupon data has been selected to be redeemed and receiving the selected digital coupon data directly from the wireless user communication device for redemption and clearing purposes.

### CROSS-REFERENCES TO RELATED APPLICATIONS

This patent application claims benefit of U.S. Provisional Patent Application Ser. No. 61/215,892 filed May 11, 2009, which is incorporated herein in its entirety by this reference.

### BACKGROUND OF THE INVENTION

1. Field of the Invention

The field of invention relates in general to wireless data transmission, and more particularly, a method to distribute, redeem, process and verify the authenticity of digital coupons via wireless networks through a master server connected to a plurality of remote servers and a user's wireless communication device.

2. Description of the Related Art

Discount coupons have been around for many years, and today, there are several methods of delivery, newspaper, magazine, Internet, and now wireless. By some estimates, over 300 billion coupons are printed and distributed every year. Billions of oddly shaped pieces of paper have to be sorted scanned and processed. The labor to process this quantity of paper is a daunting task.

The process is so labor intensive that the chance for error is high and the entire sorting and scanning process is often repeated to ensure accuracy. The face value of the coupon has to be determined during this process and an invoice generated. The face value of the coupons may be inexpensive; however, the sheer number of coupons escalates the cost of redeemed coupons totaling millions of dollars per month.

Redeemed coupons are sent in large bags to the clearing house. Upon arrival at the clearing house, the bulk of the coupons are sorted and scanned, and any coupons that are damaged have to be processed separately. The additional labor required for any special handling is charged back to the retailer. Once the coupons are sorted and a tally of the face value of the coupons is established, the clearing house generates an invoice for the retail store and manufacturer. The retail store may repeat the process of clearing for verification.

The majority of cash registers have applications that validate paper coupons verses the product scanned.

Digitized coupons which are redeemed electronically eliminate the massive task of verifying and clearing the coupons so the retailer can be paid. There are many devices that are manufactured that distribute digitized coupons via wireless methods, including via BlueTooth®, WiFi, text messaging, and Internet to cell phones. State of the art digital coupon systems are cumbersome in that they employ uploading of a barcode graphic (representative of a paper coupon) that is to be displayed on a user's cell phone. The user has to either hand the phone over to the cashier or the user has to interactively work with the cashier to manipulate the coupons serially to display subsequent coupons until all of them have been scanned. Having the cashier handle the user's phone opens up liability for the phone if it is dropped, or potential germ transfer from cashier to phone or vice versa. When the barcode graphic is displayed on the user's phone, it has to be laser scanned by an in-counter or handheld laser scanner to translate the barcode to the current prevailing 12 digit code or other identification information.

Additionally, fraud is an increasing problem for the coupon industry, $500 million of fraudulent coupons are now computer generated and distributed over the Internet. Even Internet coupons are now being turned down as the authenticity of the coupons cannot be verified at the checkout stand. Internet fraud is small compared to billions of dollars in losses due to printed coupons. The method described herein prevents fraud by authentication by the BlueTooth® radio and computer program verification.

A number of systems have been developed that address the above described problems; however, current systems are labor intensive at the retail store and have not addressed distribution and timing over large geographic areas.

### SUMMARY OF THE INVENTION

The present invention is a method of distributing, redeeming, and clearing digital coupons that includes transmitting digital coupon data directly to a wireless user communication device such as a user's cell phone and then detecting directly from the device whether any of the digital coupon data has been selected to be redeemed and receiving the selected digital coupon data directly from the wireless user communication device for redemption and clearing purposes.

### BRIEF DESCRIPTION OF THE DRAWINGS

FIG. 1 is a diagram illustrating a typical retail store configuration for clearing paper coupons in keeping with one embodiment of the present invention.

FIG. 2 is a diagram illustrating one embodiment of the present invention in which a wireless user communication device can receive and transmit digital coupon data directly to the local server or cash register.

FIG. 3 is a diagram illustrating the system of one such embodiment in which more than one wireless device have received digital coupon data.

FIG. 4 is a diagram illustrating one embodiment of the use of the components of the slave server or in-store server in one such embodiment.

FIG. 5 is a diagram illustrating a method of clearing digital coupon in keeping with one embodiment of the present invention.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The present invention is a method of distributing, redeeming, and clearing digital coupons electronically and directly through the use of customers' cell phones or other such wireless user communication devices 50. In one embodiment of the present invention, a cell phone 50 transmits digital coupon data or other store discount data directly to a retail store cash register 30. The transmission is wireless utilizing BlueTooth® or other similar wireless communication features of the cell phone 50, and the format for digital coupon data may be the current prevailing 12 digit code or other identification information transmitted from typical hard-connected barcode scanners, thereby mimicking the current barcode scanner data output. In contrast to most current digital coupon systems, which merely duplicate a paper coupon digitally to process it like a paper coupon, an embodiment of the present invention takes advantage of the wireless digital communication capabilities of the mobile phone to input the coupon data into the cash register directly.

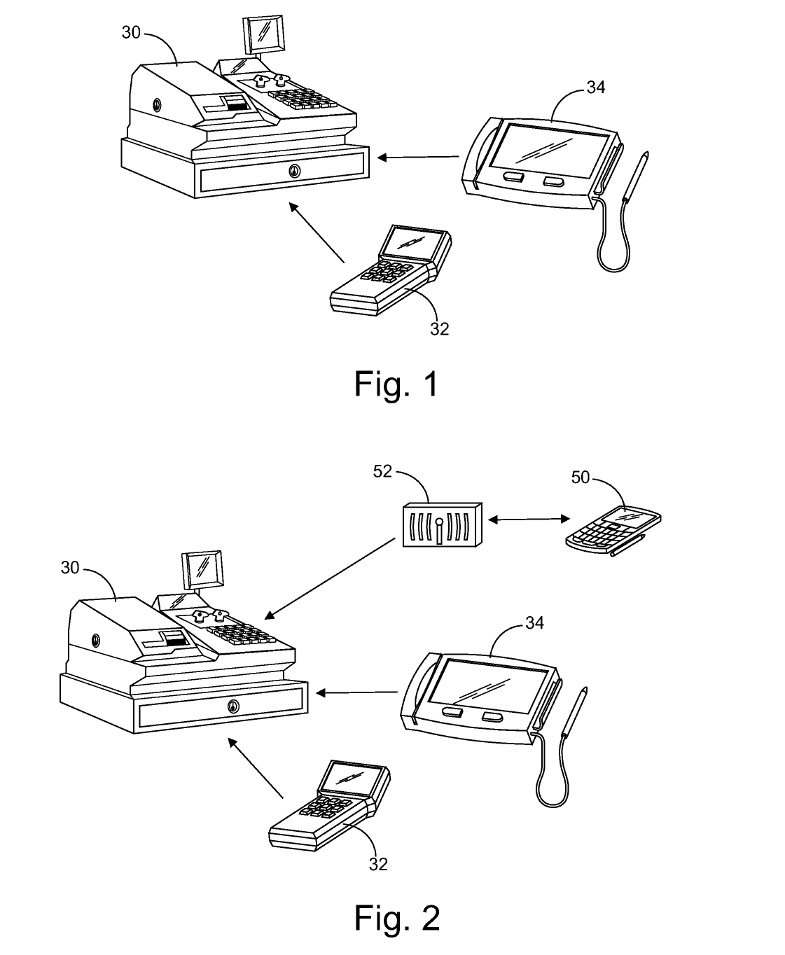

FIG. 1 illustrates a typical retail store configuration for clearing paper coupons, and FIG. 2 illustrates one configuration of the present invention in which such a wireless interface may be utilized when available to directly input the digital coupon data in the proper format for the cash register.

This embodiment of the present invention is a complete system from creation of digital coupons, to transmitting the data to a user's wireless communication device 50, to redeeming those coupons that the user selected by receiving the selected coupon data directly from the wireless device 50, to the clearing of coupons and retail store specials. The generation of a coupon or store special starts with data from the manufacturer. The minimum data to be supplied by the manufacturer or retailer is: product description, the discount, and length of time the coupon is to be run. From this data, a digital coupon is created that is known by the manufacturer and recognized by the retail store.

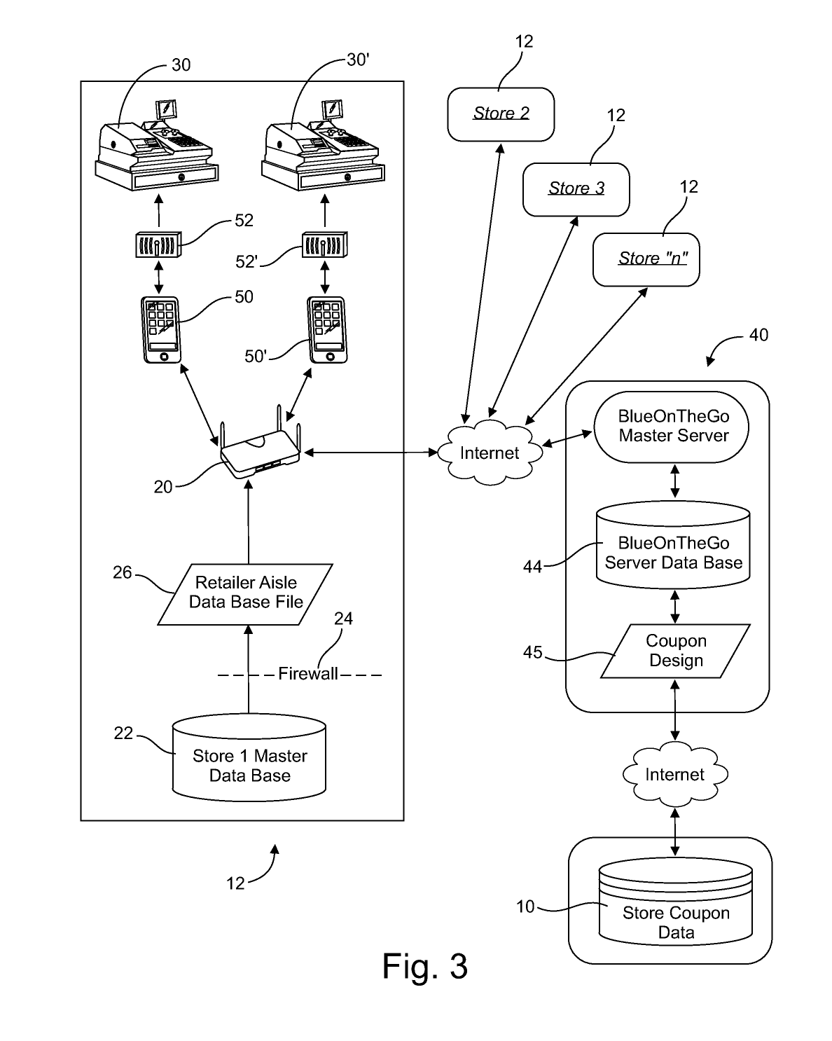

FIG. 3 shows a block diagram of one such embodiment. At the core is the master server 40, which is connected via secured Internet to the slave or in-store servers 20. Initially, a store or manufacturer determines that it needs a coupon or an in-store special discount to generate increased sales for a particular item. The digital coupon is then generated by the master server 40 for the retailer with information from the store or manufacturer.

A master database 10 stores the coupons and all pertinent information for distribution and transfers the information to the master server 40. The master server 40 may be tied to thousands of slave or in-store local servers 20 via the Internet. In every store, there will typically be a master database 22 that contains inventory information such as price, inventory, inventory location etc. Preferably, a subset 26 of the store database is placed after a firewall 24 so that the proprietary store information within the master database 22 can remain isolated and secure. A file which contains product pricing and the location where the product is located may be maintained and periodically updated at every store or retail establishment 12 for the slave server 20 to download. Pricing data allows the system to compare prices and determine the lowest cost product with coupon data transmitted by the master server 10 to the slave server 20. The slave server 20 in the retail store services coupon information to the user's cell phone 50 and interfaces with the cash register 30 for checkout.

The slave server 20 comprises a coupon and data storage unit 26, which transmits coupons through a coupon distribution unit 47 and data distribution unit 28 simultaneously. The coupons are then transmitted through a wireless interface 52 into the user's cell phone 50. The user may select or use one or more of the coupons by purchasing the product identified in the coupon data. At checkout, the selected coupon data may then be transmitted directly from the user's cell phone 50 into the cash register 30. The selected coupons are then validated through a validation protocol 48 where the authenticity of the coupons are checked.

In one embodiment, with the assistance from the store 12, the user's grocery card (or equivalent frequent shopper card) data can be utilized to distribute unique offers specifically tailored to that user. Current state of the art systems print loyalty coupons at checkout, which offer discounts that the user may redeem the next time the user visits the store 12. Thus, at most, such a typical paper-base system may generate sales only later, when the user comes back to the store 12. By contrast, the present invention sends a coupon to the user prior to checkout, which may generate a sale at the present visit to the store 12, and the user does not have to remember to bring the coupon back to the store 12.

In one embodiment of the present invention, the interaction of the user and the slave server 20 provides for real time marketing opportunities. As the user is downloading coupons or store specials, the slave server 20 learns what is in the user's shopping cart that can then be used for marketing purposes. For example, if the user downloads a coupon for tortilla chips, the slave server 20 sends a bundled (related) product coupon for bean dip or salsa. As another example, a coupon downloaded during Thanksgiving for a turkey generates coupons from the slave server 20 for yams, turkey stuffing, gravy, etc.

In contrast, state of the art systems send coupons, but do not take real-time advantage of the knowledge of what is in the user's shopping cart. The current systems still spam the user when new coupons are available losing the knowledge that “on demand” coupons offer. Delivering coupons at the time the user is putting a product in their shopping cart is very valuable for marketing other bundled products.

In one embodiment, the clearing process is simple for the user and retailer alike. The user selects a checkout stand which establishes a pairing of the cash register wireless interface device 54 and the user's wireless interface 52. In this embodiment, the application in the cell phone 50 either accepts the coupon or deletes the coupon if not used. Once the cashier has processed all the coupons, the cell phone application sends the coupons to the slave server 20 (located in the retail store). The coupon data is transmitted to the master server 40 from all retail slave servers 20 at specific times or on demand. The master server 40 tabulates the coupon redemptions and tallies the coupons by manufacturer, store and other related information required for clearing. Periodically, the clearing data is transmitted to both retail store headquarters and the manufacturer simultaneously. The checkout stand scanner data is compared to the redeemed coupon data for accuracy and verification.

The new method allows the coupons to be transmitted monthly, weekly, or even daily at the store's request. The on-demand coupon information allows manufacturers or retail stores to monitor coupon or special campaigns in real time. The system can mine data from all the remote slave servers 20 for marketing purposes.

The method and design of this embodiment can also take maximum advantage of existing hardware for a seamless operation saving time and money. An embodiment of the present invention comprises a system to wirelessly input a coupon or a retail sale special directly from a cell phone 50 into a cash register 30, and to log used coupons or specials (less any deleted coupons). The data is then transmitted wirelessly to a local slave server 20. The local slave servers 20 are located at one or more retail establishments 12, the data from one or more slave servers 20 are transmitted wirelessly or via Internet to a master server 40 for data processing and clearing.

An application is installed in the user's cell phone 50 allowing the user to populate a shopping list that is automatically updated by the local slave server 20 upon entry to the retail establishment 12 with any available discount special or coupons that may be on the shopping list. The shopping list is updated wirelessly by the local slave server 20 at any retail establishment 12 with variants of specials or other coupons that are only available at the retail establishment 12 that the user is located.

An in-store server is installed locally in a retail establishment 12 with one or more wireless interfaces or radios utilized for multiple processing of data. The wireless interfaces or radios provide a wireless communication link to the in-store server from essentially any point throughout the entire retail establishment 12. A first radio detects the user's cell phone 50 and transmits a cell phone application for execution. When new users are not being detected or being sent applications, the first radio will also process user requests for other related data. A second radio continuously sends data for coupons, specials, recipes, bundled products and other related data. The second radio continuously broadcasts streaming data and might not be used to respond to any user requests. Yet other radios, along with the first radio when not busy, may process user requests for other related information not sent by the second radio.

One or more discounts “on demand” is retrieved from a list of available discounts at the “time of decision” when the user is selecting the product for purchase. The system of the present invention may also provide aisle information, as well as pricing information, for all products wirelessly by utilizing inventory data from the retail establishment.

The application uses the discount information for automatic marketing of related bundled product discount information.

Another embodiment of the present invention is a method wherein a master server 40 connected to a slave server 20 or plurality of slave servers 20 clears digital coupons from the slave server(s) 20 through connection with the master server 40 which aggregates coupon data. The master server 40 is connected to a slave server or plurality of slave servers 20 which transmit only authorized coupons to the master server 40 for processing. The master server 40 simultaneously transmits coupon redemption data for verification and authorization by the manufacturer and the retail store 12. The data is compared to checkout cash register data and slave server data for verification.

The discount coupon is delivered automatically upon the user's arrival at a retail location 12, and is location-based specifically targeted for limited range of use around the perimeter of the user's location.

The discount coupon is automatically delivered to a cell phone 50 via BlueTooth®, WiFi, WiMAX, or Infrared radio installed at a specific location. The coupon or coupons may be automatically deleted from the user wireless device 50 upon moving out of range of the specified location and/or after a predetermined time allocation.

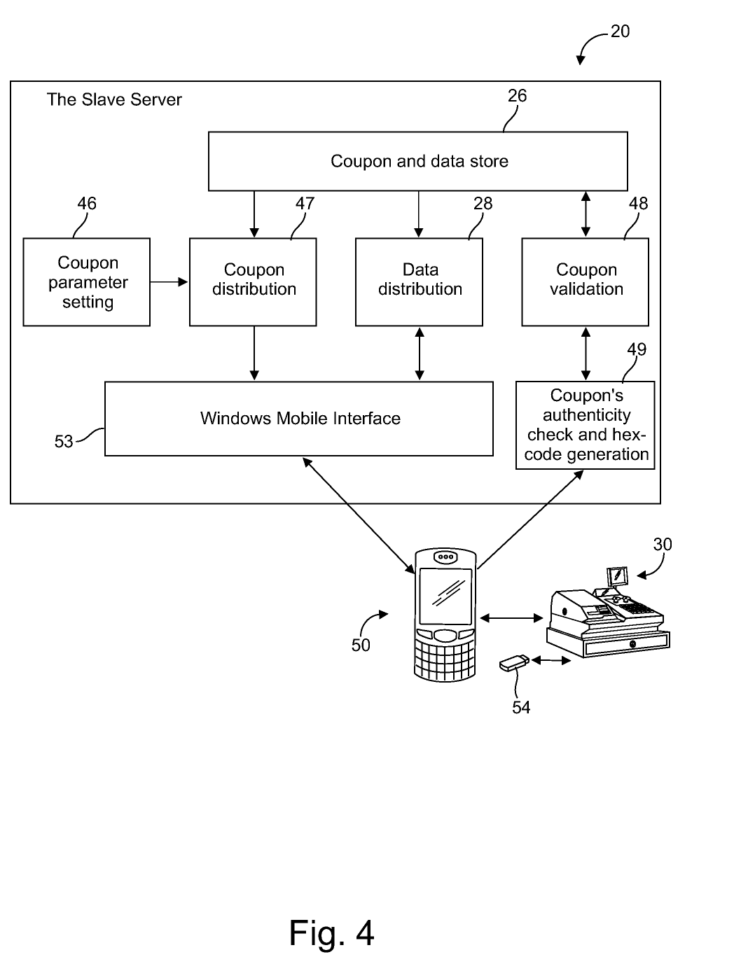

FIG. 4 demonstrates one embodiment of the use of the slave server or in-store server 20 in keeping with the present invention.

Another embodiment of the present invention uses an Internet database to locate businesses and offer suggestions and discount coupons for requested products or services based on current location.

Another embodiment of the method also includes detecting within a retail store or other predetermined geographical area 12 the presence of a wireless user communication device that has authorized the transmission of digital coupon data and delivering only those digital coupons that relate either to the user's purchasing history, the user's current shopping list, or the user's current location.

An additional embodiment of the present invention comprises a method for securing BlueTooth® transmitted digital discount coupons to a buyer's cell phone 50. The method uses a BlueTooth® radio connected to a computer with a BlueTooth® coupon application; a second BlueTooth® application installed on the user's cell phone 50 with a second BlueTooth® radio. The first application transmits digital discount coupons via the first BlueTooth® radio to second BlueTooth® radio on the user's cell phone 50. The first application authenticates the digital discount coupon residing on the user's cell phone 50, the second program controls access to the coupon upon checkout.

The digital coupon or plurality of coupons are stored in a secured memory location within the buyer's cell phone 50 controlled by the user application installed in the user's cell phone 50, and the digital coupon or plurality of coupons are recalled from the secured memory in the user's cell phone 50 serially and transmitted to the checkout counter via BlueTooth® or wireless interface 52.

The digital coupon or plurality of coupons stored in a secured memory location are retrieved from the secured memory and serially transmitted via BlueTooth® or wireless interface 52 which gates the transmission process. The BlueTooth® or wireless interface 52 is operated by the cashier and either accepts or deletes the coupon on the user's cell phone 50. The cashier verifies the validity of the coupon from cash register feedback and takes appropriate action. Sequence is repeated until all coupons have been transmitted to the cash register 30. The transaction is closed by the cash register 30 whereby the selected or used digital coupons are transmitted to the slave server 20 (less the de-selected or non-used coupons), and the coupons on the user's cell phone 50 are deleted whereby the process is terminated by pressing a done button. Upon termination of the process, the digital coupon data embedded in the coupons is transmitted to the slave server 20 for uploading to the master server 40.

The radio uploads a security code correlated to the unique identification of the user's cell phone 50 and the digital discount coupon. Upon checkout, the security code is verified through the computer and the BlueTooth® radio as a valid transmitted stock-keeping unit to the correlated user's cell phone 50.

The security code is part of a unique barcode transmitted with the coupon and is part of the unique coupon design. The security verification is an authenticity code transmitted by the user's cell phone 50 and authorized by the computer and the BlueTooth® radio at checkout. The radio and the application transmit an authorization code to allow access to the user's cell phone coupons stored in secured memory.

Another embodiment of the present invention comprises a BlueTooth® radio connected to a computer and a retail store pricing database, which calculates the lowest cost product with locally available digital discount coupons. The BlueTooth® radio or other mobile/wireless interface 53 is installed at the retail store and uploads a user program to the user cell phone 50 via BlueTooth® or wireless interface 52 upon user permission. The radio uploads digital coupons to the BlueTooth® enabled cell phone 50 upon user request. The digital coupon with the current prevailing 12 digit code or other identification information is stored in memory for retrieval upon checkout.

The radio and computer correlate purchased items via coupons uploaded and automatically sends digital discount coupons based on set product bundles to the radio and the computer is initialized with products bundled by similarity to include, but not be limited to, holidays, sports events, and religious holidays.

The radio and computer correlate purchased items to automatically send digital discount coupons from a participating competing manufacturer based on usage of competing product coupons. The radio and computer are connected to the store club card database and automatically transmits digital discount coupons based on the user's most purchased brand products prior to checkout.

The radio and computer generate automatic unique personalized digital discount coupons, which are automatically generated based on competing brand loyalty and offer much larger discounts or free product offerings based on store club card data or coupon usage. The personalized coupon is unique and not offered to other users in the retail store.

The computer logs the personalized discount coupon and allows the coupon to be redeemed one or more set number of times.

The radio and computer calculate the lowest cost per product and automatically generate a digital discount coupon to cause the participating manufacturer's product to be the lowest cost per product. The coupon automatically generates discounts up to a specific manufacturer set limit.

The user program has a product guide by aisle to assist the buyer to locate products. The computer is locally updated with daily manager specials. The computer application is connected to a database of business locations by latitude and longitude and tied to a cellular or other wireless network to upload digital discount coupons on demand. The transmission is sent via text message or Internet upon the request of a user at a specific location of a business or retail store. The location is enabled via internal cell phone GPS receiver or Time of Arrival location methods.

When the wireless server is tied to a database of business locations, the location of the business is a trigger point for coupons. The transmission, however, is not automatic since the user has to demand the coupons by transmitting a request for coupons based on his current position. In this manner, the user gets the coupons he wants when he wants them and the delivery in not a nuisance.

The discount coupon is delivered automatically upon the user's arrival at a retail location 12, and is location-based specifically targeted for limited range of use around the perimeter of the user's location. The method offers suggestions and discount coupons for requested products or services based on current location.

Therefore, a method and system are described herein for distributing, redeeming, and clearing digital coupons in an efficient, cost-effective, and waste-free manner The method comprises detecting within a predetermined geographical area 12 the presence of a wireless user communication device 50 that has authorized the transmission of digital coupon data; transmitting a first digital coupon data to the wireless user communication device, the first digital coupon data discounting a purchase item; detecting whether any of the digital coupon data has been selected to be redeemed; and receiving the selected digital coupon data directly from the wireless user communication device 50 for redemption purposes.

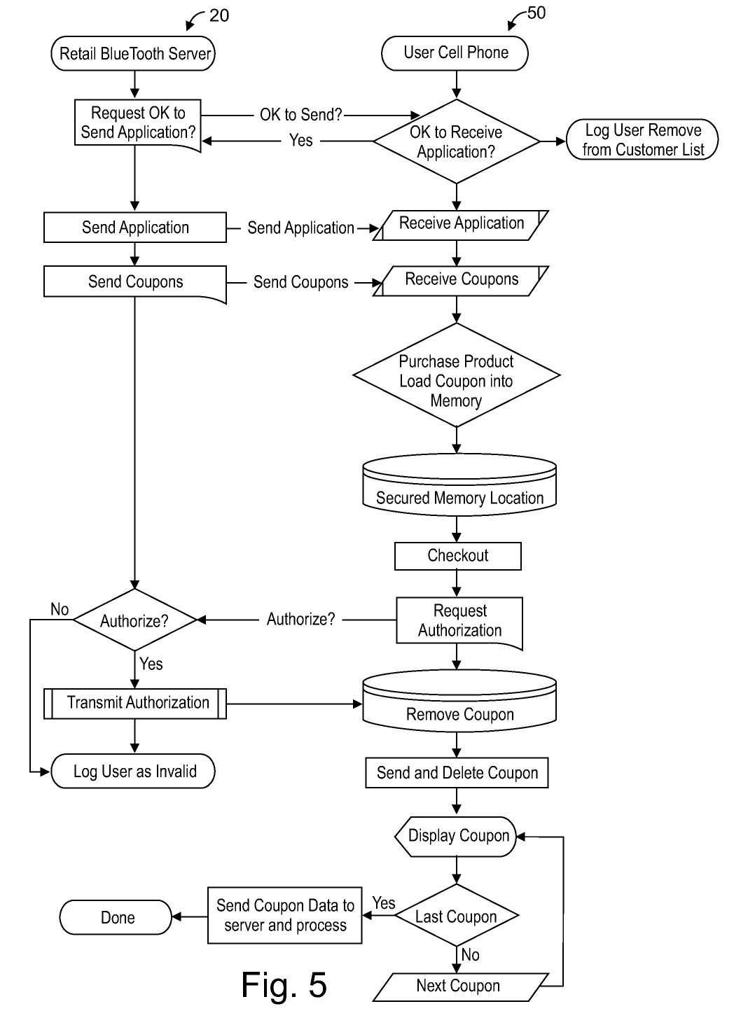

In one embodiment, such as illustrated in FIG. 5, when a user enters a predetermined geographical area 12, such as a retail establishment, a plurality of stores, a shopping mall, a shopping center, or the like, an in-store or slave server 20 automatically detects the user's cell phone 50. With the user's authorization, the slave server 20 downloads an application to the user's cell phone 50.

The slave server 20 requests authorization to send the application of the present invention to the user's cell phone 50. If the user authorizes such receipt, then the slave server 20 installs the application on the cell phone 50. If not, then the slave server 20 logs the user and removes him from the customer list.

If the user accepts the application, the slave server 20 sends the application and digital coupon data to the user's cell phone 50. The user then selects the coupons he wishes to use, optionally deletes those he does not intend to use, and purchases those products associated with the selected coupons. The selected coupons then may be loaded into a secured memory location on the cell phone 50. When the user checks out at the cash register 30, the cell phone 50 requests authorization to retrieve coupons used by the user. If authorized, the slave server 20 transmits the authorization and requests from the user's cell phone 50 a used coupon. This first used coupon is then transmitted, optionally displayed on the cell phone 50, and then deleted, and the process is repeated until the last coupon is transmitted. The coupon data is sent to the cash register 30, the customer is handed his receipt, and the process is terminated.

The predetermined geographical area 12 may be an area where a retail establishment, such as a store, a plurality of stores, a shopping mall, a shopping center, or the like is located. The retail establishment or manufacturer can utilize the system to transmit the coupon data to the user communication device 50 for a specific item of purchase so as to buy the item at a cheaper price. After the item is selected, presented to the cashier, and registered for purchase, the communication device can select and transmit the coupon data corresponding to the item selected and the register can receive the coupon data directly with a cashier or attendant manually inputting or scanning any information to redeem the coupon and discount the item.

In some embodiments, once a coupon data for a particular item is selected, the system may transmit to the wireless user communication device 50 a personalized or customized digital coupon data tailored to the purchasing history of the customer. In other words, the system may transmit customized digital coupon data that corresponds to an item related to the first item for which the first coupon data was to be redeemed. For example, the customized digital coupon data may be for a competing item, a substitute item, a complementary item, a supplementary item, a predesignated item, or a proximal item.

A competing item may be the same product made by a different manufacturer. For example, if the first purchase item was peanut butter and the first digital coupon data was for Skippy® peanut butter, then the customized coupon data may be for JIF® or the generic store brand.

A substitute item may be an item that can be used as a substitute for the original purchase item. For example, if the item was milk, then the substitute item may be soy milk or lactose free milk.

A complimentary item may be an item that often times is served or presented with a second item, such as salt and pepper.

A supplementary item may be additional items that can be used with the first item of purchase. For example, if the first item of purchase was flour, supplementary items may be eggs, sugar, milk, and the like for baking a food product.

A predesignated item may be other items on a list electronically stored in the wireless user communication device 50.

A proximal item may be any item near the user communication device 50. For example, if the user is at a shopping mall, the system can detect nearby stores and send coupon data for items in those nearby stores.

In some embodiments, the system may periodically audit selected received digital coupon data and transmit the audit results to the digital coupon supplier so that it can tailor an advertisement campaign based on the audit results. The audit may be performed once a day, twice a day, or more frequently. Alternatively, the audit may be performed less frequently, such as every other day or once a week, and so on.

The system can take the form of a computer program product accessible from a computer-usable or computer-readable medium providing program code for use by or in connection with a computer or any instruction execution system to perform the methods described herein. For the purposes of this description, a computer-usable or computer readable medium can be any apparatus that can contain, store, communicate, propagate, or transport the program for use by or in connection with the instruction execution system, apparatus, or device.

The medium can be an apparatus that can use an electronic, magnetic, optical, electromagnetic, infrared, or semiconductor system or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet can include a plurality of local area networks (“LANs”) and a wide area network (“WAN”) that are interconnected by routers. The routers are special purpose computers used to interface one LAN or WAN to another.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

While the present invention has been described with regards to particular embodiments, it is recognized that additional variations of the present invention may be devised without departing from the inventive concept.

What is claimed is:

1. A method of distributing, redeeming, and clearing digital coupons, comprising:
detecting within a predetermined geographical area the presence of a wireless user communication device that has authorized the transmission of digital coupon data;
transmitting a first digital coupon data to the wireless user communication device, the first digital coupon data discounting a purchase item;
detecting whether any of the digital coupon data has been selected to be redeemed;
transmitting a customized digital coupon data to the wireless user communication device, the customized digital coupon data corresponding to a related item selected from the group consisting of a competing item, a substitute item, a complementary item, a supplementary item, a predesignated item, and a proximal item;
receiving the selected digital coupon data directly from the wireless user communication device for redemption purposes;
periodically auditing selected received digital coupon data, wherein the audits are conducted at least once a day; and
is transmitting the audit results to the digital coupon supplier so that it can tailor an advertisement campaign based on the audit results.

2. A method of distributing, redeeming, and clearing digital coupons, comprising:
transmitting digital coupon data to a wireless user communication device;
detecting whether any of the digital coupon data has been selected to be redeemed; and
receiving the selected digital coupon data directly from the wireless user communication device for redemption and clearing purposes.

3. The method of claim 2 wherein the transmitting and receiving steps utilize a wireless interface on the wireless user communication device.

4. The method of claim 2 further comprising:
detecting the wireless user communication device within a predetermined geographical area and determining that the wireless device has authorized the transmission of digital coupon data.

5. The method of claim 2 further comprising before the receiving step, transmitting additional digital coupon data to the wireless user communication device that pertains to one or more additional items that is related to the selected digital coupon data.

6. The method of claim 2 further comprising before the transmitting step, detecting an item list resident in a memory in the wireless user communication device and tailoring the transmitted digital coupon data to correlate to one or more items on the item list.

7. The method of claim 6 wherein the tailored digital coupon data correlated to one or more items on the item list pertains to at least one competitor's item.

8. The method of claim 2 further comprising before the transmitting step, detecting the physical location of the wireless user communication device in relation to participating retail stores in the predetermined geographic area and tailoring the transmitted digital coupon data to correlate to one or more of the participating retail stores in the predetermined geographical area.

9. The method of claim 2 further comprising before the transmitting step, detecting the physical location of the wireless user communication device in relation to purchasable items in the predetermined geographic area and tailoring the transmitted digital coupon data to correlate to one or more purchasable items in the predetermined geographical area.

10. The method of claim 9 wherein the tailored digital coupon data correlated to one or more purchasable items on the item list pertains to at least one competitor's item.

11. The method of claim 2 further comprising after the receiving step, periodically auditing selected received digital coupon data and tailoring an advertisement campaign based on the results of the periodic audits.

12. The method of claim 11 wherein the audits are conducted once a day or more frequently than once a day.

13. The method of claim 2 further comprising after the receiving step, periodically auditing selected received digital coupon data and transmitting the audit results to the digital coupon supplier so that it can tailor an advertisement campaign based on the audit results.

14. The method of claim 13 wherein the audits are conducted once a day or more frequently than once a day.

15. A system for distributing and redeeming digital coupons comprising:
a first server connected to the Internet;
one or more second servers in communication with the first server via the Internet;
a cash register in communication with at least one of the second servers; and
a wireless user communication device having a wireless interface configured to communicate with the first server, the second server, or the cash register and to receive, select, and redeem digital coupon data.

16. The system of claim 15 wherein there are more than one second servers located at a single retail store to increase the area within the retail store that can be reached by the wireless communication of the second servers.

17. The system of claim 16 wherein the cash register is configured to receive digital coupon data directly from the wireless user communication device via communication with its wireless interface.

18. The system of claim 16 further comprising a computer program product stored on a computer-readable medium, the computer program product comprising instructions for causing at least one processor of the system to perform a method that delivers and redeems digital coupons, the method comprising:
detecting within a predetermined geographical area the presence of a wireless user communication device that has authorized the transmission of digital coupon data;
transmitting digital coupon data to the wireless user communication device;
detecting whether any of the digital coupon data has been selected to be redeemed; and
receiving the selected digital coupon data directly from the wireless user communication device for redemption purposes.

19. The system of claim 18 wherein the method further comprises transmitting a personalized digital coupon data to the wireless user communication device.

20. The system of claim 18 wherein the method further comprises periodically auditing the selected received digital coupon data and tailoring an advertisement campaign based on the results of the periodic audits.
